(19) United States
(12) Patent Application Publication
(10) Pub. No.: US 2020/0054416 A1
(43) Pub. Date: Feb. 20, 2020

(54) System and Apparatus for Controlling the Flexibility and Stiffness of a Superelastic Endodontic File

(71) Applicants: Gianluca PLOTINO, Rome (IT); Nicola Maria GRANDE, Rome (IT)

(72) Inventors: Gianluca PLOTINO, Rome (IT); Nicola Maria GRANDE, Rome (IT); Leonzio FORTUNATO, Torre Orsaia (Salerno) (IT)

(21) Appl. No.: 16/493,327

(22) PCT Filed: Feb. 28, 2018
(86) PCT No.: PCT/IT2018/000028

§ 371 Date: Sep. 12, 2019

(30) Foreign Application Priority Data
Mar. 13, 2017 (IT) 102017000027275

(51) Int. Cl. A61C 1/00; A61C 1/05; A61C 17/02

(52) U.S. Cl. CPC A61C 1/0015; A61C 1/0069; A61C 2201/007; A61C 17/0202; A61C 17/0217; A61C 1/052

(57) ABSTRACT

The aim of the invention disclosed herein is to control and regulate the stiffness and flexibility of an endodontic file exploiting its super-elastic and shape-memory characteristics. This result is achievable thanks to temperature-induced phase transformations of the file performed by a proper heating and cooling system managed by a control system in a handpiece. Different designs of the apparatus implementing the proposed solution are disclosed.

### TECHNICAL FIELD OF THE INVENTION

The present invention relates to the technical field of dental medical systems and methods implemented by endodontic handpieces. More particularly, the present invention is related to methods and systems involving endodontic files with super-elastic characteristics.

### BACKGROUND

A handpiece for endodontic treatments is basically composed by a motor unit including a motor or turbine having a rotatable motor shaft and a file coupling unit removably coupled to the motor unit and provided with a head to which the file is removably fixed and coupled, the head rotating the file upon rotation or reciprocation or oscillation of the motor shaft.

Development of handpieces and drilling techniques has seen the migration into these endodontic instruments of new technologies and materials such as superelastic materials. Indeed, endodontic files made of materials based on super-elastic alloys (e.g. Nickel-Titanium—NiTi) are an important part of the root canal instrumentarium.

For instance, the NiTi (namely Nitinol) is a near equiatomic intermetallic of nickel and titanium capable of exhibiting superelastic behaviour due to a stress-induced phase transformation, or shape-memory due to a temperature-induced phase transformation.

The NiTi alloy exists in two different crystal phases, martensite and austenite, which are temperature dependent. When martensitic NiTi is heated, it begins to change to austenite, and once converted to austenite, the alloy will have completed its shape-memory transformation and will display its superelastic characteristics. The temperature at which this phenomenon is complete is called the austenite finish temperature (Af). We will assume Af as a trasition temperature T in the following.

The introduction of these new materials permitted to use more flexible files in order to reduce the risk of intracanal fracture of the endodontic file.

Nevertheless, none of these solutions permits neither to improve the drilling technique in such a way to reach all parts of the root canal under treatment, especially in case of particular root canal configurations, nor to completely exclude the existing risk of intracanal fracture.

As a matter of fact, present files are suggested to be single-use due to the metal fatigue accumulation.

Therefore, the aim of the proposed invention is to avoid the drawbacks of the traditional NiTi alloy, namely separation and distortion of instruments, and of the traditional drilling techniques, developing a method for controlling the flexibility and stiffness of an endodontic super-elastic file and the device implementing said method.

The proposed solution permits to adapt the flexibility of each file at the single clinical case to reduce the main problem, namely the risk of intracanal fracture of the file.

Moreover, the invention permits to improve the quality of the treatment in particular in severely or abruptly curved and narrow root canals with respect to the traditional endodontic techniques.

Another advantage offered by the proposed invention is the possibility to safely use the same endodontic file in a greater number of treatments, with a reduced risk of intracanal fracture.

Further advantages will be more clear from the detailed description of the invention.

### DETAILED DESCRIPTION OF THE INVENTION

Since a common mechanical endodontic file is made of materials based on super-elastic alloys having a transition temperature T, we developed a method for controlling the flexibility and stiffness of such file during the intracanal treatment, according to the independent claim 1.

The first step of the method consists in the selection of a specific file, having a transition temperature T, among a set of super-elastic files with shape-memory characteristics and transition temperatures T comprised in a specific range between T₁ and T₂.

The selection is carried out by empirical measures of T, such as the well-known differential scanning calorimetry (DSC) already used for orthodontic wires [Ref.-1] or, alternatively, exploiting the well-established correlation between the fatigue resistance and the flexibility of the files under thermomechanical treatment [Ref.-2].

Before the shaping operation starts, the selected file is at the starting temperature T_{S} which can be the room temperature (20° C.) or the intracanal temperature (e.g. 35-36° C.), or is regulated to a specific value.

The next step of the method consists in adjusting the temperature of the file in order to modify its stiffness and making it more flexible or stiffer exploiting the super-elastic characteristics during the intracanal treatment. The temperature of the file may be adjusted thanks to a dedicated heating and cooling system which is managed by a control unit (CU) and a heat regulator (32), to an adjusted temperature Tₐ>T in order to make it hard and stiff, and Tₐ<T in order to make it soft and flexible. During the shaping operation the torque is measured and the adjusted temperature Tₐ is calculated according to a specific torque-temperature relationship. In the simplest cases the torque-temperature relationship can be a standard polynomial or exponential or a negative power function, but also other functions and complex combinations between them are possible.

Both the starting temperature T_{S} of the file and the torque-temperature relationship are initially set by the clinician according to the needs of the treatment, i.e. the root canal configuration. The temperature adjustment of the file can be operated either while the file is rotating (if the torque varies slowly respect to a given curve and is below a predetermined threshold) or during a stop period (until the file reaches the new temperature or up to a predetermined time limit set by the user).

This result is achievable and reproducible thanks to the selection of a file with a well-known transition temperature T, performed in the first step of the method, provided that the torque is constantly monitored and the temperature of the file is kept under control during the treatment.

It has to be stressed that the control of the temperature is crucial for the outcome of the method and to prevent possible undesired effects.

Indeed, since it is not clear how much heat is produced by friction of a file on the root canal wall during the shaping, it's not possible to exploit straightforwardly such heat in order to modify the flexibility of the file and to obtain a precise and well-controlled technical effect.

For instance, if the heat produced during the drilling operation leads to a temperature rise lower than 1.5° C. it could be insufficient to change the crystal phases of the super-elastic alloy from. On the other hand, if the temperature rise is higher than 1.5° C. it could make the file stiffer during the intracanal shaping, especially when the file has a transition temperature around the intracanal temperature, even when more flexibility is needed because of the severe canal curvature and shape.

In both cases the drilling heat could lead to undesired and uncontrolled effects on the file, which can be prevented keeping under control the temperature of the file.

Moreover, in some cases the stress-induced phase transformation to martensitic state occurring during the intracanal shaping represents a drawback for the outcome of the treatment. The proposed invention permits to counteract this effect with a thermal-induced phase transformation to austenitic state by a controlled temperature adjustment of the file.

Therefore, it has been developed a dedicated apparatus in order to implement the above-mentioned method which allows to keep under control the stiffness and flexibility of a selected endodontic file, avoiding all those possible drawbacks occurring during the intracanal shaping.

The apparatus, according to claims 5, consists in an endodontic handpiece comprising an endodontic file made of a super-elastic alloy based material which has been selected in order to have a desired transition temperature T among a set of endodontic files with transition temperature T in the range between T₁ and T₂, said apparatus including a heating and cooling system designed to adjust the temperature of the file before and during the intracanal shaping.

In addition to the heating and cooling system, that is the fundamental part of the apparatus, there is a control system comprising a heat regulator (32) and a programmable Control Unit (CU) able to acquire data coming from the motor and from other parts of the apparatus and to operate settings on the heat regulator (32) according to mathematical relationships between torque, or motor speed, and temperature.

Therefore, not only can the CU decrease or stop and reverse rotation once the set torque limit has been reached, but also it can change the temperature of the file and consequently adjust its stiffness and flexibility. The CU can be either part of the handpiece or an external device connected to the handpiece with proper cablings, and could be switched to a manual mode so as to calculate and display the temperature, leaving the clinician free to make manual settings.

Many types of handpieces comprising piping and nozzles to spread coolant fluids on the teeth have been already produced, but only with the aim to reduce the tooth temperature in order to avoid the possible thermal irritation of teeth resulting from the heat produced by friction during dental treatment procedures, such as the removal of tooth structures during the canal preparation. Despite the fact that, according to some studies [Ref.-3], the heat produced during the tooth preparation with low- and high-speed handpieces seems to increase the intrapulpar temperature of 1.8° C. and 1.4° C. respectively, it is still not clear how much heat is actually produced by friction of a file on the root wall during the shaping operation. Furthermore, in some cases the cooling of the canal, especially a straight and narrow canal, could be a drawback considering that the sum of the effects of the stress-induced transition and the temperature-induced transition to martensitic state increases the risk of fracture by torsion. Therefore the file should be heated in the case of a straight and constricted canal in order to be stiffer and should be cooled near the curvature, not near the tip, in the case of the curved canal to be more flexible. This result is obtained by the proposed invention with the heating and cooling system which induces a temperature variation mainly near the larger portion of the file so as to obtain a temperature gradient up to the tip of the file, possibly leaving the heat produced by friction on the tip to counteract the stress-induced transition to the martensitic state. More conveniently the invention permits to heat a selected file having T>35° C. up to its austenitic phase and consequently cool it down, near the curvature, below the transition temperature during the shaping operation. On the other hand, in the case of a straight and narrow canal, a file preferably selected to be in austenitic phase at intracanal temperature, can be entirely heated and stiffened, as well as a martensitic file at intracanal temperature is selected.

### EMBODIMENTS AND DRAWINGS

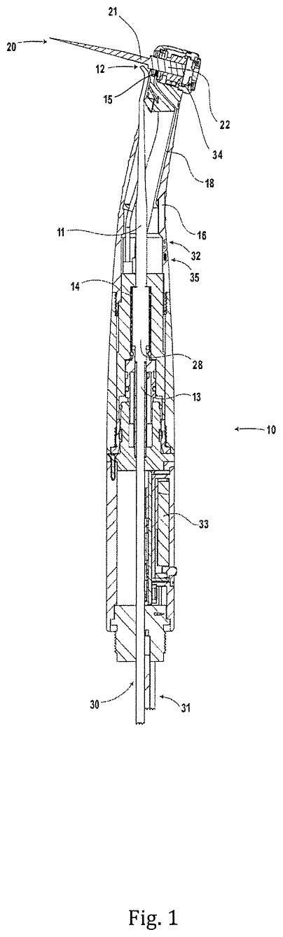

In a first embodiment (FIG. 1) of the claimed invention the method is carried out by an endodontic handpiece (10) comprising the endodontic superelastic file (20) and at least one duct (11) for spreading fluids from the orientable nozzle (12) which are properly heated and cooled by an external heating and cooling device to which the handpiece is connected by at least one dedicated piping (30) and that is managed by a heat regulator (32) placed on the handpiece or by an external device (e.g. pedals). Alternatively the fluids can be provided initially at a low temperature and heated up to a desired temperature by a heating system realized inside the handpiece with a heating chamber (28) along the inner piping (13), where said heating chamber is heated by an electrical heating means (14), e.g. a wire resistor surrounding the heating chamber or a ceramic material around which the wire resistor is coiled up (e.g. a cylindrical ceramic heater). The heating chamber (28) could also host a coiled portion of the piping (13) in order to better regulate the temperature of the flowing fluid. In both cases a possible heat control means for the heating system can be a heat regulator (32) realized inside the handpiece (e.g. a potentiometer or on/off button and +/− power buttons or a rotary power control knob) or an external one (e.g. pedals). The heating and cooling fluid can be a gas or any kind of irrigating solution. The temperature of the file is measured by a probe (15), e.g. a termocouple, placed at 1.0-1.5 mm from the end of the head portion of the file. The measured temperature is shown by a temperature display (16) connected to a Control Unit to which the probe (15) is connected by wirings (18). The control unit also acquires the speed and the torque of the motor and of the rotary portion (34) in order to automatically set the temperature on the heat regulator (32) and regulate the rotation speed of the motor. The motor speed is provided by the motor itself or is measured by a tachometer or an encoder, and the torque is measured by the current that the motor is drawing or even calculated from the well-known torque-speed relationship. The control unit may even be external to the handpiece to which is connected by wirings (31), and can also be switched to a manual mode in order to calculate and display the temperature, leaving the clinician to make settings manually.

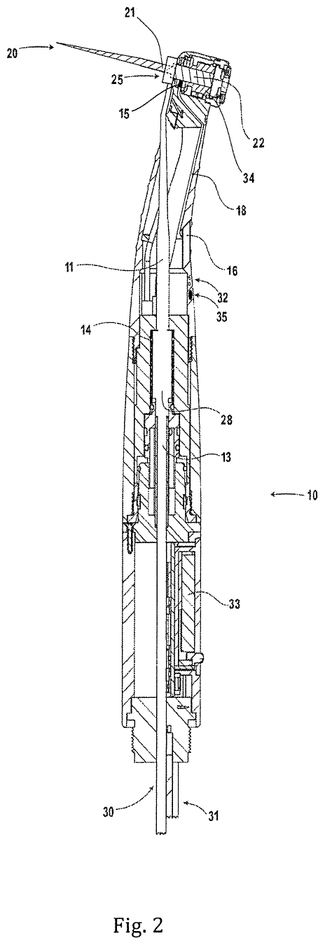

A possible alternative to the first embodiment (FIG. 2) includes a fluid containment chamber (25) filled with the fluid which flows, continuously or not, through two pipes (11) to get in and out of said chamber (25), so that the neck portion (21) of the file (20) is immersed in the fluid and the file is heated or cooled, being it in direct contact with the fluid kept at a desired temperature.

In both cases the fluids are pumped either by an internal pump or an external one (not shown in the figures) and the flow is managed by a flow control means (35), e.g. buttons onto the handpiece, or by external commands (e.g. pedals).

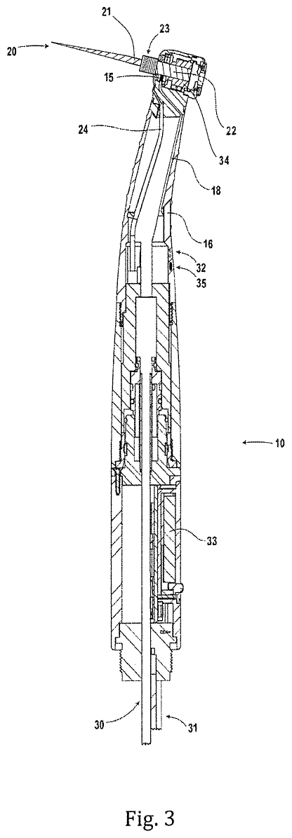

In a second embodiment (FIG. 3) of the claimed invention the heating system is an electrical heating system (23) realized by an electrical resistor, e.g. a wire resistor, placed onto the external surface of the handpiece on the edge of the hole where the file is inserted in order to surround the neck portion (21) of the endodontic file (20), near the head portion (22). Alternatively the electrical heating system (23) consists of a small protrusion, preferably of cylindrical shape, made of metallic or ceramic material around which the wire resistor is coiled up (e.g. a cylindrical ceramic heater). The electrical wire reaches the electrical resistor or ceramic heater through a dedicated wiring duct (24).

A possible alternative for the second embodiment is realized including an inner rotary portion in the electrical heating system (23) comprising a set of bearings in order to keep in contact said electrical heating system (23) with the neck portion (21) of the file (20), even placing the electrical heating system (23) near or inside the rotary portion (34) (the rotatable shaft, inside the head of the handpiece).

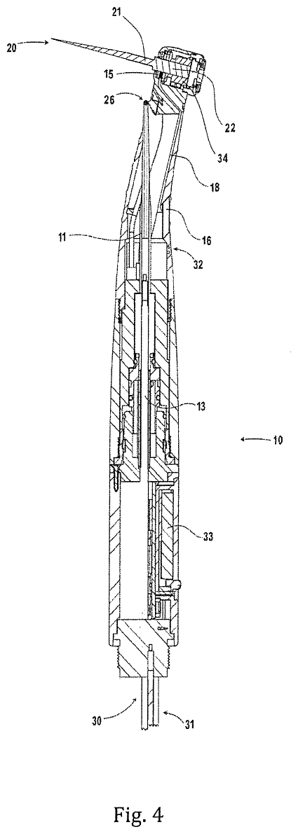

In a third embodiment (FIG. 4) of the claimed invention the heating system is a high power laser diode (26) placed onto the handpiece, or in a hollow in the handpiece, and the laser beam is oriented towards the neck portion (21) of the endodontic file (20). Alternatively the high power laser diode is placed inside the handpiece, lighting up an optical fiber which transmits the laser radiation to its end in the hole of the handpiece where the laser beam is pointed toward the neck portion (21), near the head portion (22) of the endodontic file (20). In this case the optical fiber may also be oriented towards different portions of the endodontic file (20).

In all the embodiments the electrical heating means are powered by dedicated external wirings (31) from an external power system, but it is not excluded the possibility to include in the handpiece an internal power source, such as a dedicated power battery (33), whereas the electrical current and the produced heat can be regulated by the heat regulator (32).

The temperature of the file is measured in the same way, i.e. by the probe or termocouple (15), but in the second and third embodiment it could be calculated from the electric current flowing inside the electrical heating system and from the power absorption of the power laser diode, which could be measured in a simple way.

Furthermore, the probe (15) and the display (16) could be either powered by the power battery (33) independently from the power circuit of the heating system, or they could be all included in the same power circuit, powered by the battery (33) or by an external power system.

The three embodiments could be also properly combined in such a way to obtain an apparatus with mixed heating and cooling systems so as to implement the method in claims 1-4.

A non-limiting example of a combined or mixed heating and cooling system is a fluid containment chamber (25), preferably made of metal, composed by an outer sealed cylinder filled with the fluid which is provided by the pipes (11), and an inner cylinder coupled to the outer one by bearings and being in contact with the file (20). Besides, the outer part of the containment chamber (25) could be surrounded by an electrical heating system (23). In this case the fluid can flow at low temperature so that the file is kept to a temperature lower than its transition temperature T, but it can also be heated by the electrical heating system (23) keeping the fluid at rest inside the containment chamber (25), and consequently cooled down allowing the fluid to flow also switching off the electrical heating system (23), if necessary. Moreover, the probe (15), or even a second probe, could also be placed inside the containment chamber (25) in order to measure the temperature of the fluid and of the file (when the thermal equilibrium is reached).

In a possible alternative to the previous example of mixed heating and cooling system, the cooling system is the fluid containment chamber (25) (both types, with or without bearings and rotary part, are possible) whereas the heating system is the electrical heating system (23), so that they are two independent systems which can be either separated or contiguous each other along the central axis of the file.

In each embodiment we can consider, as non-limiting examples, the following cases:
a selected super-elastic file with a transition temperature T<30° C. where the file is in austenitic state both at room and intracanal temperature. In this case the file may take advantage being cooled in order to increase its flexibility and reduce the risk for intracanal fracture particularly in curved root canals.
a selected super-elastic file with a transition temperature T>45° C. where the file is in martensitic state both at room and intracanal temperature. In this case, being the file already flexible enough to well perform in curved canals, the file may take advantage being heated in order to reduce the risk for fracture by torsion in particularly constricted canals. Moreover, it may also take advantage being cooled in order to increase its original flexibility and reduce the risk for intracanal fracture in severely curved root canals.
a selected super-elastic file with a transition temperature T in the range between 30 and 45° C.

In this case the file may take both advantages being cooled and heated, representing the ideal situation in which the clinician may adjust such parameters in a well-controlled way in order to reach the optimal adaptation to each different clinical case.

### REFERENCES

[Ref.-1]: Bradley T G, Brantley W A, Culbertson B M.—“Differential scanning calorimetry (DSC) analyses of superelastic and nonsuperelastic nickel-titanium orthodontic wires”—Am J Orthod Dentofacial Orthop 1996; 109:589-97.
[Ref.-2]: De-Deus G, Silva E J, Vieira V T, Belladonna F G, Elias C N, Plotino G, Grande N M. “Blue Thermomechanical Treatment Optimizes Fatigue Resistance and Flexibility of the Reciproc Files”. J Endod 2017 Jan. 25, DOI:10.1016/j.joen.2016.10.039
[Ref.-3]: Su-Jung Kwon, Yoon-Jung Park, Sang-Ho Jun, Jin-Soo Ahn, In-Bog Lee, Byeong-Hoon Cho, Ho-Hyun Son, and Deog-Gyu Seo—“Thermal irritation of teeth during dental treatment procedures”—Restorative Dentistry & Endodontics—Published online 2013 Aug. 23. doi: 10.5395/rde.2013.38.3.105

1-10. (canceled)

11: An apparatus for controlling and regulating a flexibility and a stiffness of an endodontic super-elastic file, the endodontic super-elastic file comprising-a hand-piece comprising a super-elastic file having a transition temperature (T), a head portion coupled to the hand-piece, a contiguous neck portion and a cutting portion forming a tip, said apparatus including a probe for measuring a file temperature, a measuring device for measuring motor speed and torque, an inner piping for fluids, and a heating and cooling system managed by a programmable Control Unit, wherein the heating and cooling system adjusts the temperature of said file from a starting temperature (T_{S}) to an adjusted temperature (Tₐ), wherein said heating and cooling system comprises at least one duct where a cooling and heating fluid is to flow towards the file, a nozzle connected to the duct to spread said cooling and heating fluid towards the file, and wherein the apparatus comprises a flow controller that controls spreading of the cooling and heating fluid, a regulator that regulates a fluid temperature of the cooling and heating fluid and controls a display, to visualize settings and measurements, wherein said Control Unit receives the torque measured by the measuring device and the starting temperature (T_{S}) of the file measured by the probe, and calculates the adjusted temperature (Tₐ) according to a mathematical relationship as a function of the measured torque, shows the adjusted temperature (Tₐ) on the display and drives the regulator to set the fluid temperature to so that: (i) the file heated to cause the adjusted temperature (Tₐ) to exceed the transition temperature (T), or (ii) the file is cooled to cause the adjusted temperature (Tₐ) to become less than the transition temperature (T), in order to control the flexibility and the stiffness of the file.

12: The apparatus of claim 11, wherein the adjusted temperature (Tₐ) is calculated by the Control Unit according to a linear or polynomial relationship with the measured torque, wherein a degree of the polynomial is greater than or equal to 2.

13: The apparatus of claim 11, wherein the adjusted temperature (Tₐ) is calculated by the Control Unit according to an exponential function or a power function of the measured torque, or a combination of the exponential function and the power function.

14: The apparatus of claim 11, wherein the heating and cooling system of the file comprises a fluid containment chamber filled with the cooling and heating fluid, wherein the cooling and heating fluid flows, through at least two ducts to get in and out of said fluid containment chamber, so that the neck portion of the file is immersed in the cooling and heating fluid.

15: The apparatus of claim 11, comprising a heating chamber placed between the inner piping and the at least one duct.

16: The apparatus of claim 15, wherein said heating chamber is heated by an electrical heater powered by an external power system or by a dedicated power battery

17: The apparatus according to claim 11, wherein the heating and cooling system comprises an electrical heating system surrounding the neck portion of the file.

18: The apparatus according to claim 17, wherein said electrical heating system is powered through electrical wires placed in a duct.

19: The apparatus according to claim 17, wherein the electrical heating system comprises an inner rotary portion with a set of bearings in order to keep in contact said electrical heating system with the neck portion of the file or with the head portion of the file, near or inside the rotary portion of the motor to which the file is fastened.

20: The apparatus according to claim 19, wherein the electrical heating system is powered by a dedicated power battery.

21: The apparatus according to claim 14, wherein the fluid containment chamber is preferably made of metal and is composed by an outer sealed container filled with the fluid which is provided by the ducts, and an inner cylinder coupled to the outer container by bearings and being in contact with the file, and wherein the outer part of the containment chamber is surrounded by an electrical heating system.

22: The apparatus according to claim 11, wherein the heating a cooling system comprises a heater, including a power laser diode placed in a casing onto the hand-piece, or in a hollow into the hand-piece, and oriented towards the file.

23: The apparatus according to claim 22, wherein the laser diode is placed inside the hand-piece and wherein said hand-piece comprises an optical fiber, between the laser diode and the exit hole for the laser beam, allowing the transmission of the laser radiation from the diode to the hole from where the laser beam can be oriented toward a portion of the file.

24: A method for controlling the flexibility and stiffness of an endodontic super-elastic file in a handpiece including a probe for measuring a temperature of the file, a measuring device for measuring motor speed and torque, and a heating and cooling system managed by a programmable Control Unit and a heat regulator, wherein the file is previously selected to have a transition temperature (T) within a range from 0° C. to 90° C., the temperature of the file is regulated to a starting value (T_{S}) before the shaping operation, and the temperature of the file is consequently adjusted to a an adjusted temperature (Tₐ) through operation of the heating and cooling system, during the shaping operation and while the torque and the temperature of the file are measured and acquired, wherein the Control Unit calculates the adjusted temperature (Tₐ) according to a linear relationship with the measured torque and sets the heat regulator to said adjusted temperature (Tₐ), so that the file is: (i) heated to cause the adjusted temperature (Tₐ) of the file to exceed the transition temperature (T) in order to make the file hard and stiff, and (ii) cooled to cause the adjusted temperature (Tₐ) of the file to become less than the transition temperature (T) in order to make the file soft and flexible.

25: The method according to claim 24, wherein the super-elastic file is selected with a transition temperature T<30° C., wherein the adjusted temperature (Tₐ) is calculated by the Control Unit according to a polynomial relationship with the measured torque, wherein a degree of the polynomial is greater than or equal to 2.

26: The method according to claim 25, wherein the transition temperature (T) is lower than a body and intracanal temperature.

27: The method according to claim 24, wherein the super-elastic file is selected with a transition temperature T>45° C., wherein the adjusted temperature (Tₐ) is calculated by the Control Unit according to a polynomial relationship with the measured torque, and wherein a degree of the polynomial is greater than or equal to 2.

28: The method according to claim 24, wherein the super-elastic file is selected with a transition temperature (T) in a range between 30° C. and 45° C.

29: The method according to claim 28, wherein the adjusted temperature (Tₐ) is calculated by the Control Unit according to an exponential function or a power function of the measured torque, or a combination of the exponential function and the power function.

30: The method according to claim 29, wherein the temperature adjustment is performed during a stop period of the shaping operation up to a predetermined time limit or until the file reaches a desired value of the adjusted temperature (Tₐ).
